(19) United States
(12) Patent Application Publication
(10) Pub. No.: US 2010/0153049 A1
(43) Pub. Date: Jun. 17, 2010

(54) Apparatus, system, and method for calculating a non-linearity metric

(75) Inventors: Mika Ventola, Oulu (FI); Antti Hiltunen, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/453,433

(22) Filed: May 11, 2009

(30) Foreign Application Priority Data
Dec. 16, 2008 (FI) 20086201

(51) Int. Cl. G01D 18/00

(52) U.S. Cl. 702/86

(57) ABSTRACT

Receiving gain factors for channels that are combined to be transmitted in a communications signal, and calculating, on the basis of the gain factors, a non-linearity metric for controlling a transmission power of the communications signal.

### RELATED FIELD

The present invention relates to calculating a non-linearity metric for controlling power amplifiers in wireless communications systems.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In devices such as mobile phones and base stations that transmit radio signals, power amplifiers (PA) are used to amplify the signals prior to their transmission. In a PA, input signals with different power levels are amplified as determined by a transfer function of the PA. When the input signal power level is in the linear operating region of the PA, the PA amplifies the input signal linearly. Input signals outside the linear operating region of the PA are amplified non-linearly or clipped if the input power is so high that it causes saturation of the PA. Thus, outside the linear operating region, the output signal of the PA becomes distorted.

PA input signals that have a high Peak to Average Ratio (PAR), such as Wideband Code Division Multiple Access (WCDMA) or Orthogonal Frequency-Division Multiplexing (OFDM) signals, require high linearity from the PA.

3^{rd} Generation Partnership Project (3GPP) standard Release 6 introduces High Speed Packet Access (HSPA). In HSPA new physical channels High Speed Dedicated Physical Control Channel (HS-DPCCH), Enhanced Dedicated Physical Data Channel (E-DPDCH) and Enhanced DPCCH (E-DPCCH) may be combined for transmission with the Dedicated Physical Data Channel (DPDCH) and Dedicated Physical Control Channel (DPCCH) already defined in Release 99 of 3GPP standards.

However, the new physical channels increase the PAR in the PA input and consequently require increased linearity from a PA designed for Release 99 physical channels. One option to meet the increased linearity requirement would be to design a new PA. However, PAs become more expensive with increased linearity in the cost and power consumption point of view. Therefore, it is desirable to use the existing Release 99 PA designs in the devices that combine HSPA and Release 99 physical channels for transmission. This is possible by controlling the PA with a power back-off so that the PA will operate on the linear region. The PA can be controlled on the basis of a non-linearity metric.

In 3GPP TS 25.101 V8.3.0 (2008-05), 3rd Generation Partnership Project; Technical Specification Group Radio Access Network; User Equipment (UE) radio transmission and reception (FDD) (Release 8), Section 6.2.2, the back-off is defined as a maximum power reduction (MPR) allowed in the User Equipment (UE) maximum transmit power. The calculation of the MPR involves calculating a non-linearity metric called a Cubic Metric (CM), which approximates the third order non-linearity caused by the PA to the transmitted signal.

One example of the CM is provided in Equations 1 and 2, where

$$\begin{matrix}{v}_{r ms}^{3} = \sqrt{\frac{1}{K} {\sum }_{k = 1}^{K} y ( k )} , \\ and & ( 1 ) \\ y ( k ) = {( {\vert x ( k ) \vert}^{2} )}^{3} , & ( 2 )\end{matrix}$$

where x(k) is a complex valued sample up-sampled and filtered signal and K is the number of samples over which the root mean square value is calculated. The power of the samples x(k) is normalized to unity.

The calculation of the CM with Equations 1 and 2 may be performed in a Digital Signal Processor (DSP) or in other programmable processing device. However, due to the powers of x(k) in Eq. 2, the above Equations may produce very large values of y(k) and CM. The presentation of the large values requires a significant number of bits. The number of bits required to represent the large values may exceed the number of bits, thus the word length, used for representing numeric values in the DSP. In such case, logarithmic and exponential function conversions can be used in the DSP for presenting large values. However, the presentation of large values with function conversions may become at the expense of increasing the number of DSP clock cycles consumed in the calculation of the CM. This may impose a need to increase the clock cycle rate of the DSP, in order to perform the calculation of the CM in a certain time frame (i.e. cycle budget).

On the other hand, mobile phones are required a low power consumption due to being battery powered. Therefore, the low power consumption is required also from components of the mobile phones, such as DSPs. In order to achieve low power consumption clock cycle rates of DSPs should be maintained at as low level as possible. However, low clock cycle rates may mean that the number of operations the DSP is able to execute in the time frame may be also limited and the operations may take a longer time to execute than when the DSP would operate with a high clock rate.

Therefore, in order to keep the clock cycle rate of the DSP low, the number of operations needed for calculating the CM should be kept low. It should also be considered that the PA may be adjusted with the back-off early enough so that the PA will have some time to settle for the back-off. Time required for PA back-off to settle limits the time frame available for calculation of the CM.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various embodiments of the invention comprise method(s), apparatus(es), computer program and a system as defined in the independent claims. Further embodiments of the invention are disclosed in the dependent claims.

According to an aspect there is provided a method comprising receiving gain factors for channels that are combined to be transmitted in a communications signal, and calculating, on the basis of the gain factors, a non-linearity metric.

According to another aspect there is provided an apparatus configured to receive gain factors for channels that are combined to be transmitted in a communications signal, and calculate, on the basis of the gain factors, a non-linearity metric.

According to another aspect there is provided an apparatus comprising means for receiving gain factors for channels that are combined to be transmitted in a communications signal and means for calculating, on the basis of the gain factors, a non-linearity metric.

According to another aspect there is provided a computer program comprising instructions which are operable to control a data processing means to perform a method according to an aspect of the invention.

According to another aspect there is provided a system comprising one or more apparatuses according to aspects of the invention.

Although the various aspects, embodiments and features of the invention are recited independently, it should be appreciated that all combinations of the various aspects, embodiments and features of the invention are possible and within the scope of the present invention as claimed.

Some aspects provide improvements that may comprise for example one or more of the following: an increased time frame for calculation of the non-linearity metric, reduced number of computational operations needed in the calculation of the non-linearity metric and/or savings in power consumption in calculators calculating the non-linearity metric. Further improvements will become apparent from the accompanying description.

### BRIEF DESCRIPTION OF THE DRAWINGS

The invention will be described in greater detail by means of exemplary embodiments with reference to the attached drawings, in which:

FIG. 1 illustrates an exemplary apparatus where certain embodiments of the present invention may be applied;

FIG. 2A illustrates exemplary functional blocks of an apparatus according to one embodiment of the present invention;

FIG. 2B illustrates exemplary functional blocks of an apparatus according to one embodiment of the present invention;

FIG. 3A illustrates exemplary functional blocks of an apparatus for multi-carrier communications exemplary according to one embodiment of the present invention;

FIG. 3B illustrates exemplary functional blocks of an apparatus for multi-carrier communications according to one embodiment of the present invention;

FIG. 4A illustrates exemplary functional blocks in a calculator for calculating a non-linearity metric according to one embodiment of the present invention;

FIG. 4B illustrates exemplary functional blocks in a calculator for calculating a non-linearity metric according to one embodiment of the present invention;

FIG. 4C illustrates exemplary functional blocks in a calculator for calculating a non-linearity metric according to one embodiment of the present invention;

FIG. 5 illustrates an exemplary process for calculating a non-linearity metric according to one embodiment of the present invention;

FIG. 6 illustrates an exemplary process for calculating a non-linearity metric according to one embodiment of the present invention;

FIG. 7 illustrates an exemplary process for calculating a non-linearity metric according to one embodiment of the present invention.

### DESCRIPTION OF EXEMPLARY EMBODIMENTS

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The present invention may be applicable to any transmitter, user terminal, base station, access point, corresponding component, and/or to any communication system or any combination of different communication systems that employ power amplifiers. The communication system may be a fixed communication system or a wireless communication system or a communication system utilizing both fixed networks and wireless networks. The protocols used, the specifications of communication systems, transmitters, user terminals, base stations and access points, especially in wireless communication, can develop rapidly. Such development may require extra changes to an embodiment. Therefore, all words and expressions should be interpreted broadly and they are intended to illustrate, not to restrict, the embodiment.

Embodiments of the present invention may be implemented in various devices and systems that transmit radio signals such as handheld and infrastructure communications devices. Examples of the devices comprise user equipment (UE), mobile phones, base stations, Node-Bs, relay stations, access points, for example.

User equipment may refer to any user communication device. A term “user equipment” as used herein may refer to any device having a communication capability, such as a wireless mobile terminal, a PDA, a smart phone, a personal computer (PC), a laptop computer, a desktop computer, etc. For example, the wireless communication terminal may be an UMTS or GSM/EDGE smart mobile terminal having S60 operating system from Nokia Corporation. Thus, the application capabilities of the device according to various embodiments of the invention may include native S60 applications available in the terminal, or subsequently installed applications.

The connections shown in the Figures, describing one or more apparatuses according to the present invention, are logical connections; the actual physical connections may be different. It is apparent to a person skilled in the art that the systems also comprise other functions and structures. Different blocks in the apparatuses may be combined and implemented in single physical or logical entities. It should be appreciated that different blocks in the Figures may also be divided and implemented in one or more physical or logical entities.

In the following exemplary embodiments, a term non-linearity metric can refer to a metric that approximates a non-linearity of a power amplifier. In an embodiment the approximated non-linearity may be a third order non-linearity and a non-linearity metric may be the CM. However, it should be appreciated that the embodiments are not restricted to the third order non-linearity. Therefore, the embodiments and their teachings are also applicable to any order of non-linearity and may be used to calculate a non-linearity metric of any order.

In the following exemplary embodiments, a term signal state may refer to the states a communications signal may have. The signal states may be presented by samples of finite lengths comprising one or more bits or bytes. Accordingly, in the following the operations that are performed using signal states of a communications signal may also be preformed using samples of the signal states and vice versa. The signal states may comprise symbols of various kinds of modulation methods, for example symbols of Phase-Shift Keying (PSK), Frequency-Shift Keying (FSK), Amplitude-Shift Keying (ASK), Quadrature Phase Shift Keying (QPSK), Quadrature Amplitude Modulation (QAM), Continuous Phase Modulation (CPM), Orthogonal Frequency Division Multiplexing (OFDM), wavelet modulation, Trellis Coded Modulation (TCM) including their combinations, variants and derivatives. The signal states may further comprise coded symbols of the above modulation schemes such as space time coded symbols for example in communications applying Multiple Input Multiple Output (MIMO) technology as well as combinations of several coded symbols.

The communications signal may have actual and computational signal states. A transmitted communications signal may comprise the actual signal states of the communications signal. The computational signal states may be representative of the actual signal states and may be used instead of the actual signal states for controlling the power amplifier.

In the following exemplary embodiments, the mathematical notations and calculations that are used may be considered as exemplary i.e. their purpose may be to describe the physical implementation. A person skilled in the art may also use other notations, calculations and/or formulas to implement the embodiments and/or to reach a similar effect, without departing from the scope of the embodiments. For example, in some of the below embodiments, calculation of the non-linearity metric may be described using the mathematical notations and/or formulas that apply to complex values that have a real valued part and an imaginary valued part. However, it should be apparent to a person skilled in the art that in practice the notations and/or formulas using complex values may be implemented with real values that represent the real and imaginary parts. For example, in practice, a power of a complex value may be calculated as a square sum of the real values representing the real and imaginary parts of the complex value.

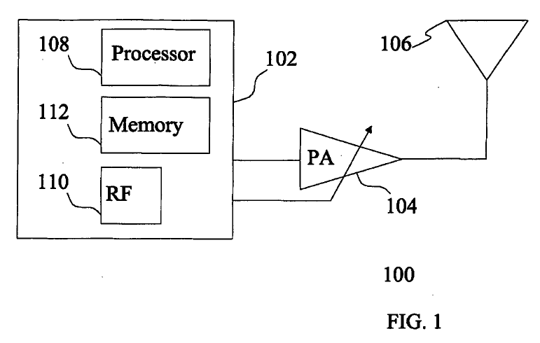

FIG. 1 illustrates an apparatus 100 according to one exemplary embodiment. Although the apparatus has been depicted as one entity, different modules and memory may be implemented in one or more physical or logical entities.

The apparatus comprises a transmitter 102 connected to a PA 104. The one or more signals generated in the transmitter may be provided as input to the PA to be amplified for transmission via at least one antenna 106 that may be connected to the output of the PA. The transmitter may further configured to control the operating point of the PA.

The transmitter 102 may generally include a processor, controller, control unit or the like 108 connected to a memory 112 and to various interfaces of the apparatus. Generally, the processor is a central processing unit. The processor 108 may comprise a computer processor, an embedded processor, a Digital Signal Processor (DSP), a Master Control Unit (MCU) or an Application Specific Integrated Processor (ASIP), an Application-Specific Integrated Circuit (ASIC), a Field-Programmable Gate Array (FPGA), any kind of processor or chip that is programmable to execute numeric calculations and/or other hardware components that have been programmed in such a way to carry out one or more functions of an embodiment.

The processor 108 may be configured to perform signal processing and calculations for generating a communications signal to be transmitted. The generated communications signal may be a baseband (BB) communications signal. The BB communications signal may comprise frequencies starting from equal or very near to zero. The communications signal may be provided as input to an RF unit for transmission on a radio link.

In addition to tasks related to generating a communications signal, the processor 108 may be configured to perform other tasks. In an exemplary embodiment, the other tasks may include calculating a non-linearity metric for controlling the power amplifier. The non-linearity metric may be a CM, for example. The non-linearity metric may be used in the processor to generate a control signal to control the PA.

Details of controlling the PA by using non-linearity metric such as a CM, are well known to a person skilled in the art, and will not be discussed here, so as to avoid obscuring the exemplary embodiment with unnecessary detail.

The transmitter may comprise an RF (Radio Frequency) unit 110 configured to transfer the generated communications signal to a higher frequency band for transmission on a radio link via the antenna 106. The RF unit may comprise parts of the transmitter that for transferring the generated communications signal from the BB to a frequency band the signal is to be transmitted on as a radio signal over a radio link. The parts may comprise, for example, one or more of an oscillator and a filter, but are not limited thereto. The RF unit may also be configured to perform other tasks and include other parts, however, those will not be discussed here in more detail, as those are well known to a skilled person, and could obscure the exemplary embodiment with unnecessary detail.

The memory 112 may include volatile and/or non-volatile memory and typically stores content, data, or the like. For example, the memory 112 may store computer program code such as software applications (for example for the processor unit and/or for the RF unit) or operating systems, information, data, content, or the like for the processor 108 to perform steps associated with operation of the apparatus in accordance with embodiments. In the illustrated embodiment, the memory 112 may store data, values and/or instructions for calculating a non-linearity metric. The memory may be, for example, random access memory (RAM), a hard drive, or other fixed data memory or storage device. Further, the memory, or part of it, may be removable memory detachably connected to the apparatus.

The apparatus of FIG. 1 may be configured to generate communications signals to be transmitted on a radio link according to a specific technology or family of standards such as Global System for Mobile Communications (GSM), General Packet Radio Service (GPRS), Enhanced Digital GSM Evolution (EDGE), or Evolution of GSM (E-GSM), Code Division Multiple Access (CDMA), Wideband Code Division Multiple Access (WCDMA), High-Speed Uplink Packet Access (HSUPA), High-Speed Downlink Packet Access (HSDPA), Orthogonal Frequency Division Multiple Access (OFDMA), Time Division Multiple Access (TDMA), IEEE 802.xx, Digital European Cordless Telecommunication (DECT), Infrared (IR), Wireless Fidelity (Wi-Fi), Bluetooth, and other standardized as well as non-standardized systems.

The apparatus in FIG. 1 may be a user terminal that is a piece of equipment or a device that associates, or is arranged to associate, the user terminal and its user with a subscription and allows a user to interact with a communications system. The user terminal may present information to the user and may allow the user to input information. In other words, the user terminal may be any terminal capable of receiving information from and/or transmitting information to the network, connectable to the network wirelessly or via a fixed connection. Examples of the user terminal may include a personal computer, a game console, a laptop (a notebook), a personal digital assistant, a mobile station (mobile phone), and a line telephone.

In exemplary embodiments units of the apparatus 100 may be software and/or software-hardware and/or firmware components (recorded indelibly on a medium such as read-only-memory or embodied in hard-wired computer circuitry).

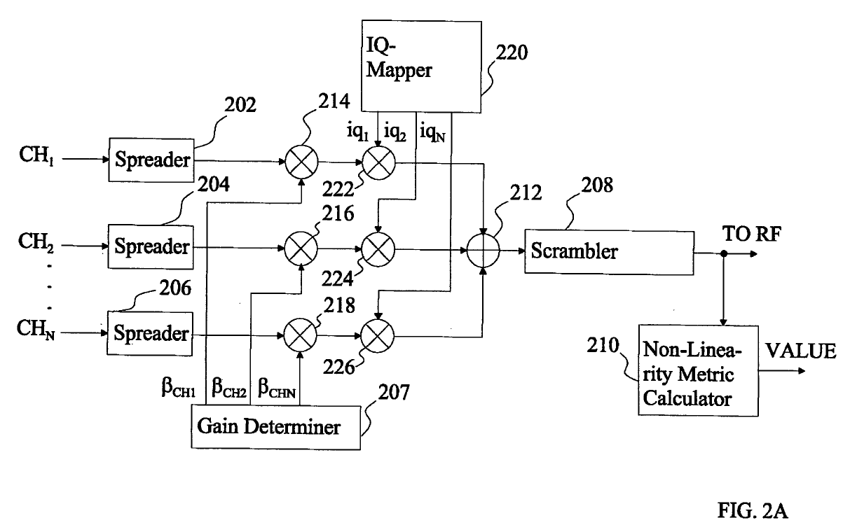

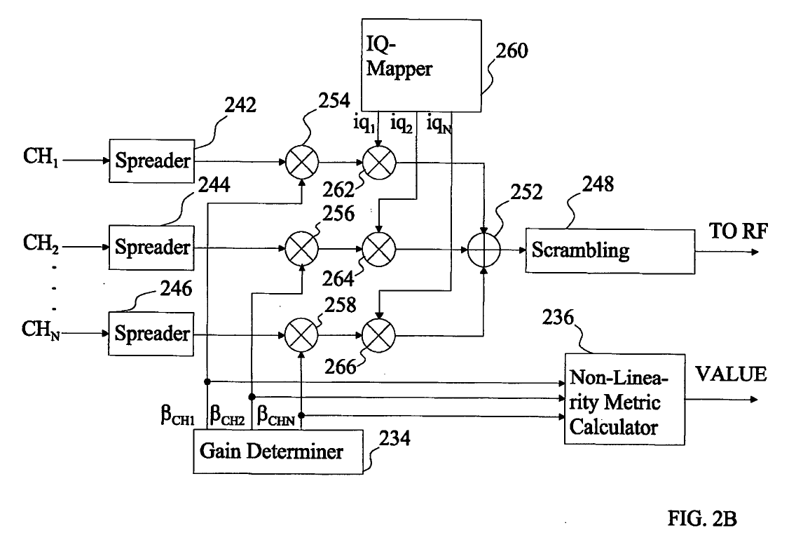

FIGS. 2A and 2B illustrate functional blocks of apparatuses according to exemplary embodiments. In the Figures only blocks of the apparatus necessary for understanding the invention are shown for clarity reasons. The functional blocks may be implemented in the apparatus described in FIG. 1, for example in the processor 108.

In the FIGS. 2A and 2B, the functional blocks that generate a communications signal to be transmitted and calculate a non-linearity metric for controlling a PA are illustrated. The non-linearity metric may be a CM, for example. The communications signal may be a BB signal suitable to be transmitted on a shared communications channel. The shared communications channel may be a frequency band, where communications signals from multiple apparatuses may be communicated at the same time. The communications signal may comprise a plurality of channels that have been combined for transmission. The channels may be physical channels, for example.

In one exemplary embodiment, the communications signal is may be a spread spectrum signal such as a WCDMA signal.

In the following the functional blocks illustrated in FIG. 2A are explained according to an exemplary embodiment employing WCDMA technology.

In spreader blocks 202, 204 and 206, input samples of symbols on physical channels (CH₁, CH₂, . . . , CH_{N}) may be multiplied with channelization codes. By multiplying each channel with its channelization code, the physical channels that may be combined in a summer 212 may be separated in the receiver. The input samples to spreaders may be samples with a symbol rate Rₛ. The output of the each of the spreader may be spread in frequency with respect to the input as defined by the ratio of the channelization code chip rate to the symbol rate R_{c}/Rₛ. Accordingly, after the spreading the sampling rate may be the chip rate R_{c}.

A gain factor determiner 207 may be configured to determine a gain factors β_{CH}(1), β_{CH}(2), . . . , β_{CH}(n), . . . , β_{CH}(N) for each physical channel CH₁, CH₂, . . . , CH_{N}. In determining the gain factor for a physical channel, the desired channel data rate, parameters from protocol layers above the physical layer and in some cases also the maximum allowed transmission power for the apparatus may be used to determine the gain factor for each channel.

The gain factor may be used to apply weighting to each of the physical channels, and each gain factor may be determined relative to a reference value. By weighting each physical channel their power may be controlled.

The gain factor determiner may provide, as output the gain, factors β_{CH}(1), β_{CH}(2), . . . , β_{CH}(n), . . . , β_{CH}(N) of physical channels to multipliers 214, 216 and 218 each of which may be associated with a physical channel. Each of the multipliers may be configured to receive the gain factor of the physical channel the multiplier may be associated with and multiply the associated physical channel with the received gain factor. Accordingly, each of the physical channels may be weighted on the basis of the gain factor received in the multiplier.

In the context of 3GPP WCDMA, the gain factor determiner may be configured to receive input parameters for gain factor determination from higher layers, thus layers above the physical layer. The gain factors may be determined in the gain factor determiner as described in Section 5 in 3GPP TS 25.214 V8.3.0 (2008-09), Technical Specification, 3rd Generation Partnership Project; Technical Specification Group Radio Access Network; Physical layer procedures (FDD), (Release 8) the Section 5 of 25.214. The gain factor may be directly proportional to the amplitude and power of the channel that is transmitted from the UE towards the NodeB. The power of the DPCCH may be controlled by the NodeB by the power control commands (UP, DOWN), and the power of other channels that may be transmitted are set according to rules described in 3GPP TS 25.214 Section 5, and are constrained by the total transmit power available in the UE. Details concerning the gain factors and their computation are currently specified in 3GPP TS 25.214, section 5.1 “Uplink Power Control”.

An IQ-mapper 220 may be configured to map each physical channel (CH₁, CH₂, . . . , CH_{N}) for transmission on either I or Q branch. The mapping of physical channels on I and Q branches can be done for example as defined in 3GPP TS 25.213 V8.2.0 (2008-09) Technical Specification 3rd Generation Partnership Project; Technical Specification Group Radio Access Network; Spreading and modulation (FDD) (Release 8) 3GPP TS 25.213, section 4.2, Table 1C. According to the 3GPP TS 25.213, the mapping may comprise controlling multipliers 222, 224 and 226, each of which may be associated with a physical channel, to multiply the associated physical channel with ‘1’ if the physical channel is mapped for transmission on the I branch or multiplication with \sqrt{−1} (referred as ‘j’ in the complex notation) if the physical channel is mapped for transmission on the Q branch. Accordingly, each of the multipliers may be configured to receive a mapping control signal such as ‘1’ or ‘j’ from the IQ-mapper and multiply the associated physical channel using the received mapping control signal.

The mapping of channels to I and Q branches may result in a sum of real and complex valued samples when the physical channels are combined in the summer 212. The summer may be configured to provide as output a communications signal to be transmitted and the communications signal comprising the physical channels. The communications signal may be a complex communications signal.

A scrambler 208 may scramble the communications signal received from the summer and comprising physical channels CH₁, CH2, . . . , CH_{N}. The scrambling may be performed with a scrambling code that enables a receiver to separate communications signals from different WCDMA transmitters that use the shared communications channel. The scrambled communications signal may be provided as input to further functional blocks, such as a pulse shape filter for adapting the waveform of the communications signal to the communications channel, a digital-to-analog converter for converting the samples of the communications signal into an analogue signal and further as input to an RF unit, such as RF unit 110 to be transmitted on a radio link.

A non-linearity metric calculator 210 may be configured to calculate a non-linearity metric for controlling the PA. The non-linearity metric may be calculated on the basis of the samples of the scrambled communications signal. The non-linearity metric may be a CM. The calculator provides the calculated value of the non-linearity metric as output to be used in controlling a PA, such as the PA 104 in FIG. 1.

In one exemplary embodiment, the non-linearity metric calculator 210 may calculate the value of the non-linearity metric from the samples of the communications signal prior to the scrambling operation, for example from the communications signal output from the summer.

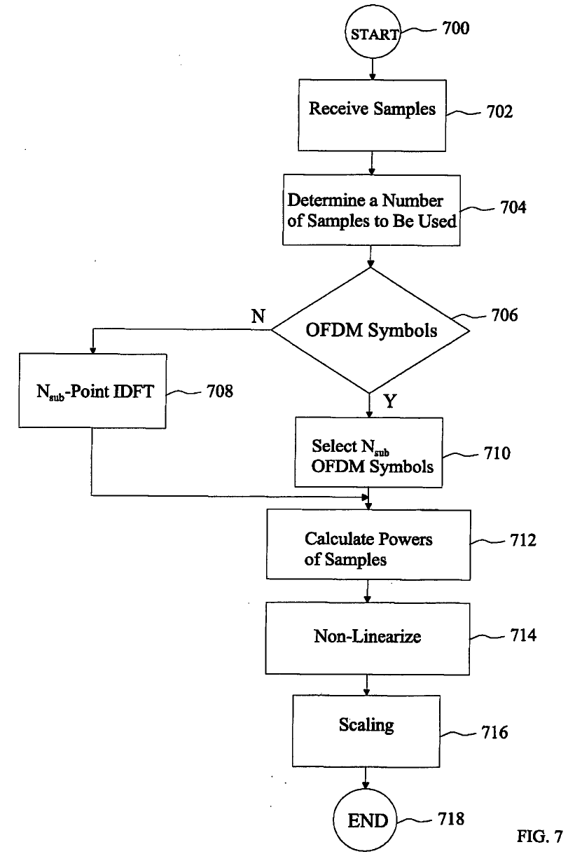

In one exemplary embodiment, the calculator may be configured to calculate the non-linearity metric from a reduced number of samples of the communications signal. In selecting the reduced number of samples, the calculator may be configured to apply a method described in more detail in the following description, for example with FIG. 6.

When the calculator receives the input signal prior to up-sampling and/or pulse shape filtering, the calculation of the non-linearity metric may be started earlier than if the communications signal after up-sampling and/or pulse shape filtering would be used, for example. This may increase the time frame available for the calculation of the non-linearity metric, for example.

When the calculation of the metric may be started earlier, the value of the non-linearity metric for controlling a PA may be available earlier. Thus, the PA may for example have more time to settle for the power back-off determined on the basis of the non-linearity metric value.

As the time frame available for calculating the non-linearity metric may be increased advanced power saving methods may be applied to reduce the power consumed in the calculation of the non-linearity metric, for example.

When the calculator is configured to calculate the non-linearity metric from a reduced number of samples of the communications signal the number of computational operations may be reduced compared to that if all the samples were used. This may allow for example applying advanced power saving methods to reduce the power consumed in the calculation of the non-linearity metric.

In FIG. 2B, the functional blocks of spreaders (242 to 246), multipliers (254 to 258 and 262 to 266), an IQ-mapper (260), summer (252), scrambler (248) and a gain determiner (234) correspond to those in FIG. 2A. As a difference to FIG. 2A, gain factors β_{CH}(1), β_{CH}(2), . . . , β_{CH}(n), . . . , β_{CH}(N) determined in the gain determiner 234 may be provided as input to the non-linearity metric calculator 236. The non-linearity metric calculator may be configured to receive gain factors from the gain determiner and to calculate a value of the non-linearity metric on the basis of the received gain factors.

When the input samples to the non-linearity metric calculator are received from the gain factor determiner the calculation of the non-linearity metric may be started earlier than if the input samples were received from output of the summer, scrambler or even later functional blocks. This may increase the time frame available for the calculation of the non-linearity metric, for example.

When the calculation of the non-linearity metric may be started earlier the value of the non-linearity metric value for controlling a PA may be available earlier. Thus, the PA may, for example, have more time to settle for the power back-off determined on the basis of the value of the non-linearity metric.

As the time frame available for the calculation of the non-linearity metric may be increased, advanced power saving methods may be applied to reduce the power consumed in the calculation, for example.

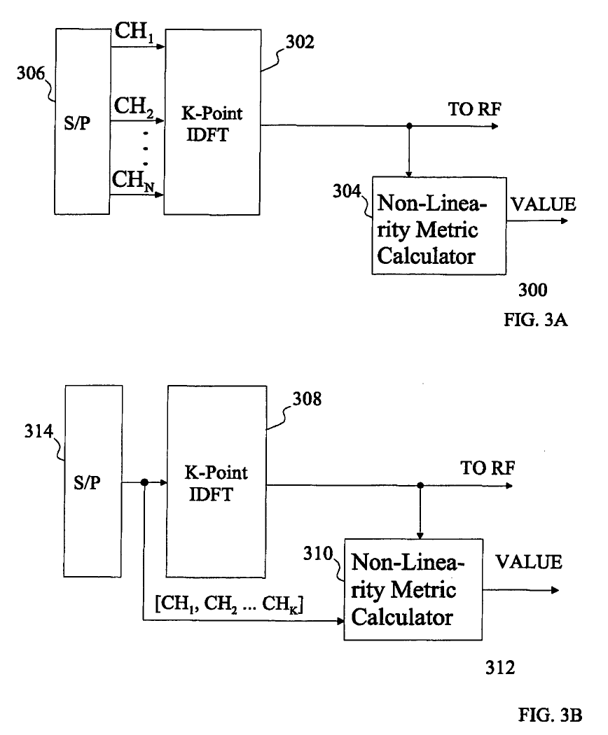

FIGS. 3A and 3B illustrate functional blocks of apparatuses 300 and 312 for multi-carrier communications according to exemplary embodiments. In the Figures, only certain blocks of the apparatus are shown for clarity reasons. The functional blocks may be implemented in the apparatus described in FIG. 1, for example, in the processor 108.

In the FIGS. 3A and 3B, the functional blocks that may generate a communications signal to be transmitted and calculate a non-linearity metric for controlling a PA are illustrated. The non-linearity metric may be a CM, for example. The communications signal may be formed of a plurality K of sub-carrier samples x(k) that may be combined using a K-point Inverse Discrete Fourier Transform (IDFT) into a communications signal to be transmitted. Accordingly, the communications signal may be a multi-carrier signal comprising a plurality of sub-carriers. The communications signal may be a BB signal that is suitable to be transmitted via an RF unit, such as RF unit 110, in FIG. 1.

In the following, the functional blocks illustrated in FIG. 3A are explained according to an exemplary embodiment employing OFDM technology.

A serial-to-parallel converter 306 may provide samples of physical channels CH₁, CH2, . . . , CH_{K,} each of which may correspond to a sub-carrier to be transmitted, as input to an IDFT block 302. The samples on each physical channel may be symbol rate Rₛ samples corresponding to the modulation scheme of the sub-carrier.

The IDFT block may perform a K-point inverse Fourier transform to the samples received as input and forms a communications signal to be transmitted that comprises OFDM symbols. The OFDM symbols may be provided as input to further functional blocks, such as a pulse shape filter for adapting the waveform of the communications signal to the communications channel, a digital-to-analog converter for converting the samples of the communications signal into an analogue signal and further to the RF unit such as the RF unit 110 in FIG. 1.

The OFDM symbols formed in the IDFT block may be provided as input to a non-linearity metric calculator 304. The calculator may be configured to calculate a value of non-linearity metric from the OFDM symbols and provide the calculated value as output to be used in controlling a PA, such as the PA 104 in FIG. 1.

When the non-linearity metric calculator receives the input signal prior to up-sampling and/or pulse shape filtering, the calculation of the non-linearity metric may be started earlier than if the up-sampled and/or pulse shape filtered signal would be used. This may increase the time frame available for the calculation of the non-linearity metric, for example.

When the calculation of the metric may be started earlier, the value of the non-linearity metric for controlling a PA may be available earlier. Thus, the PA may, for example, have more time to settle for the power back-off determined on the basis of the non-linearity metric value.

As the time frame available for the calculation of the non-linearity metric may be increased, advanced power saving methods may be applied to reduce the power consumed in the calculation of the non-linearity metric, for example.

FIG. 3B illustrates functional blocks of an apparatus, where the IDFT block 308 and S/P block 314 corresponds to IDFT block 302 and S/P block 306 in FIG. 3A.

A non-linearity metric calculator 310 may be configured to calculate a value of a non-linearity metric from samples of physical channels received from the S/P block 314.

When the input samples to the calculator are received prior to forming the communications signal to be transmitted in the IDFT the calculation of the value of the non-linearity metric may be started earlier, for example. This may increase the time frame available for calculating the value of the non-linearity metric.

When the calculation of the value of the non-linearity metric may be started earlier the value of the non-linearity metric for controlling a PA may be available earlier. Due to that PA may for example have more time to settle for the power back-off determined on the basis of the value of the non-linearity metric.

As the time frame available for the calculation of the non-linearity metric is increased advanced power saving methods may be applied to reduce the power consumed in the calculation of the non-linearity metric, for example.

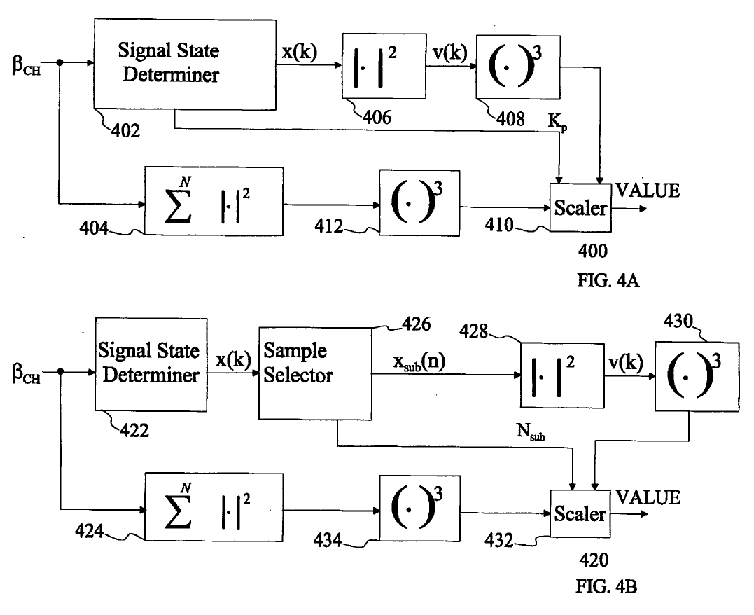

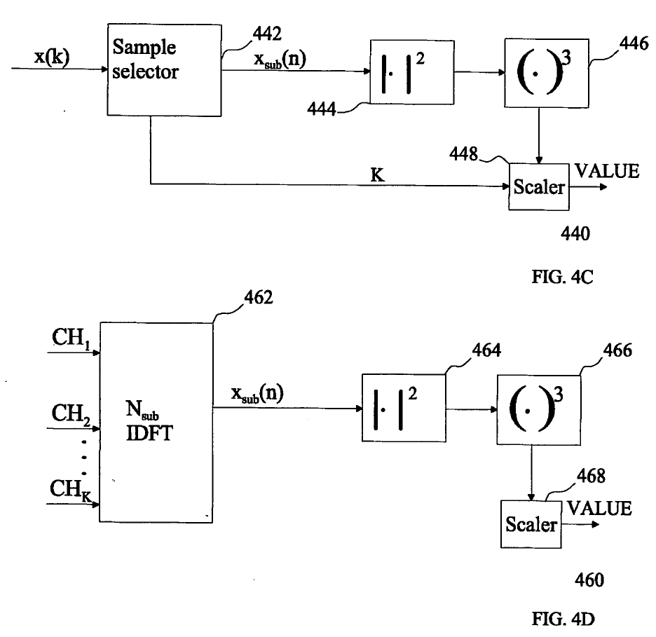

FIGS. 4A and 4B illustrate functional blocks of non-linearity metric calculators 400 and 420 for calculating a value of the non-linearity metric according to an exemplary embodiment. The non-linearity metric may be a CM, for example. In FIGS. 4A and 4B the value of the non-linearity metric may be calculated from computational signal states of a communications signal to be transmitted. The computational signal states may comprise states that the communications signal may have prior to up-sampling and/or pulse shape filtering. The non-linearity metric calculator may be the non-linearity metric calculator in the embodiment described in FIG. 2B.

In some embodiments, the non-linearity metric calculator may be configured to receive samples β_{CH}(1), β_{CH}(2), . . . , β_{CH}(n), . . . , β_{CH}(N) that correspond to gain factors of physical channels that are to be combined for transmission in the communications signal.

In the following, the functional blocks of the non-linearity metric calculator 400 illustrated in FIG. 4A will be described. The non-linearity metric calculator may comprise a signal state determiner 402 configured to determine, on the basis of the received samples β_{CH}(1), β_{CH}(2), . . . , β_{CH}(n), . . . , β_{CH}(N), Kₚ samples corresponding to computational signal states x(k) in a communications signal to be transmitted. The signal states may be constellation points (CPs) in the communications signal to be transmitted, for example.

As the signal states may be determined from the gain factors and not directly from the actual communications signal to be transmitted, the signal states in this case may be computational signal states that correspond to the actual signal states of the communication signal. The non-linearity metric calculator may comprise power calculators 404 and 406 that may be configured to calculate power values of samples. The power calculator 406 may be configured to calculate power values of the computational signal states x(k) received from the signal state determiner. The power calculator 404 may be configured to calculate a square sum of the gain factors β_{CH}(1), . . . , β_{CH}(2), . . . , β_{CH}(n), . . . , β_{CH}(N) by calculating power values of the gain factors β_{CH}(1), . . . , β_{CH}(2), . . . , β_{CH}(n), . . . , β_{CH}(N) and adding them together.

Non-linearizers 408 and 412 may be configured to non-linearize the values calculated in 404 and 406.

The non-linearizer 408 may be configured to non-linearize the values calculated in 406. The non-linearizer 412 may be configured to non-linearize the value calculated in 404. When the non-linearity metric may be a cubic metric, the non-linearizing that may be performed in calculators 408 and 412, may be a cubing-operation.

The non-linearized values calculated in the non-linearizers 408 and 412 may be provided as input to a scaler 410 that may be configured to scale the non-linearized values calculated in 408 with the non-linearized value calculated in 412 and with the number of samples Kₚ corresponding to signal states x(k) determined in the signal state determiner. The scaling may produce a value of the non-linearity metric at the output of the scaler. Further details on scaling will be explained below.

In the following, the functional blocks of the non-linearity metric calculator 420 illustrated in FIG. 4B will be described. The non-linearity metric calculator may comprise a signal state determiner 422, power calculators 428 and 424, non-linearizers 430 and 434, and a scaler 432 that may correspond with the respective blocks in the non-linearity metric calculator 400 described with FIG. 4A.

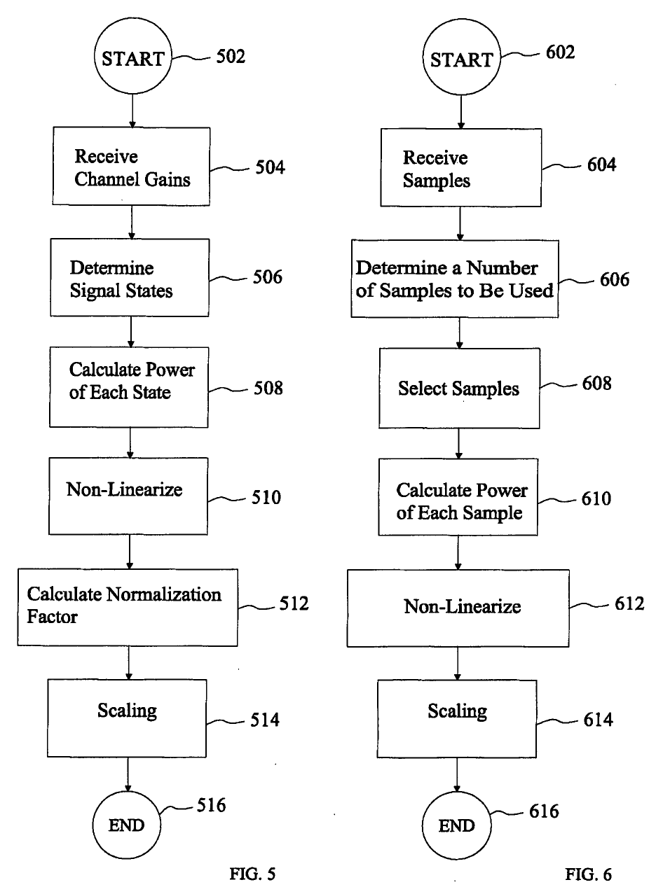

As a difference to the embodiment described in FIG. 4A, in FIG. 4B, a sample selector (signal state selector) 426 is introduced that may operate between the signal state determiner and the power calculator. The sample selector may be configured to select a reduced number (i.e. a subset) N_{sub} of the samples corresponding to signal states determined in the signal state determiner. The reduced number of samples ( x̅_{sub}) may be provided as input to the power calculator that follows the sample selector. The sample selector may be configured to provide the number of selected samples N_{sub} to the scaler to be used in scaling. The details of the operation of the sample selector will be described below with FIGS. 5, and 6.

By using a reduced number of the samples in the blocks following the sample selector, the number of computational operations needed in the calculation of the non-linearity metric may be decreased and more time may be left for the PA to settle. In this exemplary embodiment power may be saved due to the reduced number of computational operations consumed in the calculation of the non-linearity metric.

FIG. 4C illustrates functional blocks in a non-linearity metric calculator 440 for calculating a non-linearity metric according to an exemplary embodiment. In the embodiment, the non-linearity metric may be calculated from the signal states of a communications signal to be transmitted. The signal states may be actual signal states of the communications signal. The signal states may be determined prior the up-sampling and/or pulse shaping. The non-linearity metric may be a CM, for example. The non-linearity metric calculator 440 may be used in any of the apparatuses illustrated in FIG. 2A or 3A.

In the embodiment, a sample selector (signal state selector) 442 may be in the non-linearity metric calculator that may be configured to receive a number K samples x(k), corresponding to the signal states of the communications signal to be transmitted, and to select a reduced number of N_{sub} samples x_{sub}(n) from the received samples x(k). The received samples may chip or symbol level samples of a communications signal comprising combined physical channels and the power of the samples x(k) is normalized to unity.

The operation of the power calculator 444 and non-linearizer 446 correspond to the operation of the respective blocks in the non-linearity metric calculator in the embodiment of FIG. 4B.

A scaler 448 may be configured to scale the values calculated in the non-linearizer 446 on the basis of the number of samples K received as input to the non-linearity metric calculator, thus according to Eq. (1). Further details on scaling will be explained below.

Exemplary improvements obtainable with the embodiment illustrated in FIG. 4B may also be obtained with the embodiment illustrated in FIG. 4C. As in the embodiment illustrated in FIG. 4C, the scaling may be performed as conventional, existing scalers that perform scaling according to Eq. (1) may be used with the embodiment. Accordingly, improvements that may be provided by the embodiment illustrated in FIG. 4C may further comprise for example savings of computational cost and/or time in implementing non-linearity metric calculators.

FIG. 4D illustrates functional blocks in a non-linearity metric calculator 460 for calculating a non-linearity metric from K samples of physical channels CH₁, CH₂, . . . , CH_{K} corresponding to sub-carriers to be transmitted in a communications signal according to an exemplary embodiment. The non-linearity metric calculator may be a non-linearity metric calculator 460 in the apparatus illustrated in FIG. 3B.

In the embodiment K samples each corresponding to a sub-carrier may be received as input to the non-linearity metric calculator 460. The non-linearity metric calculator may comprise an N_{sub} point IDFT block 462 that may be configured to select a reduced number N_{sub} of samples from the received K samples and to perform IDFT on the selected reduced number of samples N_{sub}. The IDFT block produces OFDM symbols that may correspond to the selected reduced number of samples. The operation of the power calculator 464 and non-linearizer 466 may correspond to the operation of the respective blocks 428 and 430 in the non-linearity metric calculator in the embodiment of FIG. 4B.

A scaler in 468 in the non-linearity metric calculator may receive the values from the non-linearizer 466 and scales them proportional to the number N_{sub} points in the IDFT block 462. Further details on scaling will be explained below.

When the IDFT is performed to a reduced number N_{sub} of the K samples to be transmitted, the number of OFDM symbols in the computations performed in the functional blocks following the IDFT 462 may be reduced compared with using OFDM symbols generated by a K-point IDFT. Accordingly, the improvements may further comprise for example that the value of the non-linearity metric may be calculated with a reduced number of computational operations and/or there may be more time for the PA to settle. Due to the reduced number of computational operations used in the calculation of the non-linearity metric, the improvements may further comprise for example that power may be saved.

In the embodiment of FIG. 4D, the non-linearity metric calculator may receive as input samples of sub-carriers to be transmitted, thus samples prior to combining them for example in K-point IDFT in FIG. 3B to be transmitted in the communications signal. The N_{sub}-point IDFT may require less computational operations to perform than the K-point IDFT. Accordingly, in FIG. 4D, the OFDM symbols for calculation of the value of the non-linearity metric may be obtained in less time and the time for the PA to settle may be increased compared to the embodiment in FIG. 3A.

FIG. 5 illustrates a process 500 for calculating a value of a non-linearity metric for controlling a power amplifier according to an exemplary embodiment. In the embodiment, the non-linearity metric may be calculated on the basis of gain factors β_{CH}(1), . . . , β_{CH}(2), . . . , β_{CH}(n), . . . , β_{CH}(N) of channels that are combined to be transmitted in a communications signal. The gain factors may be used to determine computational signal states of the communications signal for calculating the non-linearity metric. The non-linearity metric may be a CM. The process may be performed in a non-linearity metric calculator such as the non-linearity metric calculator illustrated in FIG. 4A or 4B. FIG. 2B illustrates examples of functional blocks of an apparatus implementing the non-linearity metric calculator. The process begins in 502.

The gain factors β_{CH}(1), . . . , β_{CH}(2), . . . , β_{CH}(n), . . . , β_{CH}(N) of channels that may be combined to be transmitted in a communications signal are received in 504. The gain factors may be gain factors of physical channels. Each of the gain factors may be associated with a physical channel mapped to be transmitted on I or Q branch (i.e. real and imaginary parts in a complex modulation). Accordingly, each of the gain factors β_{CH}(1), . . . , β_{CH}(2), . . . , β_{CH}(n), . . . , β_{CH}(N) may be a gain factor for either I or Q branch. The I channel gain factors may be denoted by β_{I}(1),β_{I}(2),β_{I}(3), . . . ,β_{I}(n), . . . ,β_{I}(N_{βI}) and the Q channel gain factors may be denoted by β_{Q}(1),β_{Q}(2),β_{Q}(3), . . . β_{Q}(n), . . . ,β_{Q}(N_{βQ}), where n denotes the channel index, N_{βI} is the number of gain factors in I channel and N_{βQ} is the number of gain factors in Q channel. Each gain factor may be presented with a finite sample value. The non-linearity metric may be calculated on the basis of the gain factors as will be described in the following steps.

Signal states of the communications signal may be determined in 506. The signal states may be computational signal states or actual signal states of the communications signal. The computational signal states may be constellation points, for example. Each of the signal states may be presented with a finite sample value in the calculation of the non-linearity metric. The computational signal states may be determined on the basis of the received gain factors. The determining may be performed in the signal state determiner 402 in FIG. 4A or signal state determiner 422 in FIG. 4B, for example. The actual signal states may be determined from received communications signal to be transmitted and comprising channels weighted on the basis of the gain factors. The determined signal states may define corresponding samples to be used in the calculation of the non-linearity metric.

The computational signal states in the communications signal to be transmitted may be determined by calculating all the combinations of the gain factors β_{I}(1),β_{I}(2),β_{I}(3), . . . β_{I}(n), . . . ,β_{I}(N_{βI}) and/or β_{Q}(1),β_{Q}(2),β_{Q}(3), . . . β_{Q}(n), . . . ,β_{Q}(N_{βQ}) in each branch. The computational signal states of I branch s̅ᵢ may be presented by:

$$\begin{matrix}{\overline{s}}_{l} = [ \begin{matrix}{s}_{i} ( 1 ) \\ {s}_{i} ( 2 ) \\ {s}_{i} ( 3 ) \\ ⋮ \\ {s}_{i} ( k ) \\ ⋮ \\ {s}_{i} ( {K}_{i} - 1 ) \\ {s}_{i} ( {K}_{i} )\end{matrix} ] \\ = {β}_{l} ( 1 ) \pm {β}_{l} ( 2 ) \pm {β}_{l} ( 3 ) \pm … {β}_{l} ( {N}_{β l} - 1 ) \pm {β}_{l} ( {N}_{β l} ) .\end{matrix} \qquad ( 3 )$$

The computational signal states of Q branch s̅_{q} may be obtained in a similar way by:

$$\begin{matrix}{\overline{s}}_{Q} = [ \begin{matrix}{s}_{q} ( 1 ) \\ {s}_{q} ( 2 ) \\ {s}_{q} ( 3 ) \\ ⋮ \\ {s}_{q} ( k ) \\ ⋮ \\ {s}_{q} ( {K}_{q} - 1 ) \\ {s}_{q} ( {K}_{q} )\end{matrix} ] \\ = {β}_{Q} ( 1 ) \pm {β}_{Q} ( 2 ) \pm {β}_{Q} ( 3 ) \pm … {β}_{Q} ( {N}_{β Q} - 1 ) \pm {β}_{Q} ( {N}_{β Q} ) .\end{matrix} \qquad ( 4 )$$

The number of gain factors in each branch may be defined by the number of physical channels mapped to be transmitted in the branch. Accordingly, the mapping of channels may affect the number of computational signal states Kᵢ in I branch and the number of computational signal states K_{q} in Q branch, thus the lengths of the vectors s̅ᵢ and s̅_{q}. If a different number of channels are mapped to I and Q branches, the signal state vectors s̅ᵢ and s̅_{q} may be of different lengths. If a channel that is mapped on I or Q branch is not active, its gain factor is zero. The computational signal states of the communications signal comprising signal states of I branch and Q branch may be expressed by:

p(kₚ)=sᵢ(kᵢ)+js_{q}(k_{q}) (5)

where kᵢ=[1 . . . Kᵢ], k_{q}=└1 . . . K_{q}┘, kₚ=K_{q}(kᵢ−1)+k_{q} and Kₚ=KᵢK_{q}.

In one example, physical channels are mapped on I and Q branches as described in 3GPP TS 25.213 referenced earlier. In the example the maximum number of active channels in Q branch is four (i.e. N_{βQ}=4) and the maximum number of active channels in I branch is three (i.e. N_{βI}=3). Therefore, K_{q}=2^{N}^{_{βQ}}⁻¹=8 and Kᵢ=2^{N}^{_{βI}}⁻¹=4. As the maximum number of active channels may be higher in the Q branch, the maximum length of the signal state vector in Q branch may be longer than the corresponding vector in I branch. According to this exemplary embodiment the computational signal states of I-branch s̅_{I} may be calculated by

$${\overline{s}}_{l} = [ \begin{matrix}{s}_{i} ( 1 ) \\ {s}_{i} ( 2 ) \\ {s}_{i} ( 3 ) \\ {s}_{i} ( 4 )\end{matrix} ] = [ \begin{matrix}{β}_{l} ( 1 ) + {β}_{l} ( 2 ) + {β}_{l} ( 3 ) \\ {β}_{l} ( 1 ) + {β}_{l} ( 2 ) - {β}_{l} ( 3 ) \\ {β}_{l} ( 1 ) - {β}_{l} ( 2 ) + {β}_{l} ( 3 ) \\ {β}_{l} ( 1 ) - {β}_{l} ( 2 ) - {β}_{l} ( 3 )\end{matrix} ] , \qquad ( 6 )$$

and the computational signal states of Q branch s̅_{Q} may be calculated by

$${\overline{s}}_{Q} = [ \begin{matrix}{s}_{q} ( 1 ) \\ {s}_{q} ( 2 ) \\ {s}_{q} ( 3 ) \\ ⋮ \\ {s}_{q} ( 7 ) \\ {s}_{q} ( 8 )\end{matrix} ] = [ \begin{matrix}{β}_{Q} ( 1 ) + {β}_{Q} ( 2 ) + {β}_{Q} ( 3 ) + {β}_{Q} ( 4 ) \\ {β}_{Q} ( 1 ) + {β}_{Q} ( 2 ) + {β}_{Q} ( 3 ) - {β}_{Q} ( 4 ) \\ {β}_{Q} ( 1 ) + {β}_{Q} ( 2 ) - {β}_{Q} ( 3 ) + {β}_{Q} ( 4 ) \\ {β}_{Q} ( 1 ) + {β}_{Q} ( 2 ) - {β}_{Q} ( 3 ) - {β}_{Q} ( 4 ) \\ {β}_{Q} ( 1 ) - {β}_{Q} ( 2 ) + {β}_{Q} ( 3 ) + {β}_{Q} ( 4 ) \\ {β}_{Q} ( 1 ) - {β}_{Q} ( 2 ) + {β}_{Q} ( 3 ) - {β}_{Q} ( 4 ) \\ {β}_{Q} ( 1 ) - {β}_{Q} ( 2 ) - {β}_{Q} ( 3 ) + {β}_{Q} ( 4 ) \\ {β}_{Q} ( 1 ) - {β}_{Q} ( 2 ) - {β}_{Q} ( 3 ) - {β}_{Q} ( 4 )\end{matrix} ] . \qquad ( 7 )$$

According to this example, the number of computational signal states (Kₚ) that may be calculated by using Eq. 5, is (2²*2³)=32.

In an exemplary embodiment, the determining of the signal states in 506 may comprise determining a reduced number (i.e. a subset) N_{sub} of signal states p(1) . . . p(K_{p,red}), thus N_{sub}=K_{p,red}, from the computational signal states p(1) . . . p(Kₚ) or from the actual signal states determined from received communications signal to be transmitted. The determining may comprise selecting the reduced number of signal states from the actual signal states of the communications signal to be transmitted or from the computational signal states determined in Eq. 5.

Selecting the reduced number N_{sub} (i.e. a subset) of signal states may reduce computational complexity of the calculation of the non-linearity metric. The selection and the definitions of the subset may be expressed by

$$[ \begin{matrix}p ( 1 ) \\ p ( 2 ) \\ p ( 3 ) \\ ⋮ \\ p ( {k}_{p} ) \\ ⋮ \\ p ( {K}_{p} - 1 ) \\ p ( {K}_{p} )\end{matrix} ] selection funtionality [ \begin{matrix}{p}_{red} ( 1 ) \\ {p}_{red} ( 2 ) \\ ⋮ \\ {p}_{red} ( {k}_{p , red} ) \\ ⋮ \\ {p}_{red} ( {K}_{p , red} )\end{matrix} ] , \qquad ( 8 )$$

where K_{p,red}≦Kₚ. The selection can be done by using the sample selector 442 in FIG. 4, for example. The selecting a reduced number of signal states p_{red}(1),p_{red}(2), . . . ,p_{red}(k_{p,red}), . . . ,p(K_{p,red}) may comprise omitting a part of the signal states p(1),p(2), . . . ,p(kₚ), . . . ,p(Kₚ) and/or selecting a signal states that meet one or more selection criteria.

In an exemplary embodiment the reduced number N_{sub} of signal states may be determined as the signal states in s̅_{I} and/or s̅_{Q} that are in a single quadrant of the complex plane. The quadrant may be any of the four quadrants of the complex plane. Accordingly, the determining may comprise determining whether a signal state is in the single quadrant and if it is, selecting the signal state to the reduced number of signal states. The selection may be performed to signal states of both branches, as in Eq. 5 or to signal state vectors of each branch separately. In the latter case, the quadrant may be different for each branch.

When signal states in a single quadrant are selected the number of samples used in the calculation of the non-linearity metric may be considerably smaller than in the case in which all four quadrants are used. For example, if the number of active channels is 7, the maximum number of signal states may be 2³*2⁴=128. With the above embodiments of determining the signal states in a single quadrant, the reduced number of signal states (K_{p,red}) may be only (2³*2⁴)/4=32, thus ¼^{th}.

In an exemplary embodiment the reduced number N_{sub} of signal states may be determined by omitting at least one additive inverse value of the signal states. By definition, the additive inverse, or opposite, of a number n may be the number that, when added to n, yields zero. Accordingly, additive inverse values may comprise values that are the same, but have opposite signs and/or that are complex conjugates. For example, additive inverse values may be omitted from the computational signal states of I branch s̅_{I} in Eq. (3), from the computational signal states of Q branch s̅_{Q} in Eq. (4) and/or the computational signal states comprising all branches p(1) . . . p(Kₚ). The omitting may comprise identifying additive inverse values of signal states and selecting the reduced number of signal states such that the number of additive inverse values is reduced, substantially zero or zero in the selected reduced number of signal states. For example, the selecting may comprise removing additive inverse values from the computational signal states of I branch s̅_{I}, Q branch s̅_{Q} and/or the computational signal states comprising all branches p(1) . . . p(Kₚ).

Accordingly, in the embodiment when at least one additive inverse value is omitted from signal state vectors of I and Q branch the number of signal states used in the calculation of the metric may be reduced to comprise ¼^{th} of the signal states s̅_{I} and s̅_{Q} defined by the gain factors. For example, if the number of active channels is 7, the maximum number of signal states may be 2³*2⁴=128. With the above embodiments by omitting the additive inverse values and including only unique values, the number of signal states could be reduced to (2³*2⁴)/4=32, thus to ¼^{th}.

Consequently, when the number of signal states is ¼^{th} of all signal states the computational complexity of the calculation of the non-linearity metric may be reduced without degrading the accuracy of the non-linearity metric. Using only signal states of a single quadrant and/or omitting at least one additive inverse value may be possible because the other three quadrants and/or additive inverse values contain redundant information and thus cause redundant calculations in calculating of the non-linearity metric. The redundancy may be due to that the second order operation according to the Eq. 5 requires only absolute values and the sign of signal state is meaningless.

In an exemplary embodiment the reduced number N_{sub} of signal states may be selected as described in steps 604, 606 and 608 in FIG. 6. The signal states may be the computational signal states or the actual signal states. In an exemplary embodiment, the sample selector 442 may be configured to select the reduced number of signal states (N_{sub}) according to, for example, the magnitude of computational signal state. The magnitude can be, for examples, the amplitude of signal state |p(k)| or, alternatively, the power of signal state |p(k)|². For example, at least the signal state of greatest amplitude may be selected. For example, assuming that
the signal states are p(1)=15+j30, p(2)=45+j15, p(3)=15+j45, p(4)=90+j90, p(5)=30+j90, p(6)=15+j15; and
the sample selector 442 may be configured to determine a reduced number of signal states N_{sub}=K_{p,red}=4 according to the amplitudes of the signal states
   the subset becomes p_{red}(1)=45+j15, p_{red}(2)=15+j45, p_{red}(3)=90+j90 and p_{red}(4)=30+j90 due to the fact that their amplitudes are the greatest of all six signal states. The justification of the selection may be that the signal states that have the highest amplitude dominate the calculation of the non-linearity metric due to the high amplitude (and correspondingly, powers) of the signal states as can be seen in Eqs. 1 and 2. Therefore it is possible to discard the terms that have smallest amplitudes and still maintain accuracy that fulfills the requirements.

In an exemplary embodiment the reduced number N_{sub} of signal states may be selected by omitting at least one of multiple occurrences (i.e. redundant information) of each signal state value. The omitting of at least one of the multiple occurrences may comprise identifying multiple occurrences of signal state values and selecting the reduced number of signal state values such that the number of multiple occurrences is reduced, substantially zero or zero in the selected reduced number of signal states. A multiple occurrence of a signal state value may be defined as the same absolute value of signal state value occurring more than once in a signal state vector. Multiple occurrences of signal state values may be omitted from the computational signal states of I branch s̅ᵢ in Eq. (3), from the computational signal states of Q branch s̅_{q} in Eq. (4) and/or the computational signal states comprising all branches p(1) . . . p(Kₚ). When multiple occurrences are omitted corresponding information of the multiple occurrences, such as the number of occurrences of each signal state value in a signal state vector, may be stored. For example, each signal state vector s̅ᵢ and s̅_{q} may be checked for multiple occurrences of signal state values. When multiple occurrences are omitted from I branch signal state vector s̅_{I}, a signal state vector

$${\overline{s}}_{l , occ} = [ \begin{matrix}{s}_{i , occ} ( 1 ) \\ {s}_{i , occ} ( 2 ) \\ {s}_{i , occ} ( 3 ) \\ ⋮ \\ {s}_{i , occ} ( k ) \\ ⋮ \\ {s}_{i , occ} ( {K}_{i , occ} )\end{matrix} ] \qquad ( 9 )$$

comprising K_{i,occ} unique values may be formed. Similarly, s̅_{Q,occ} may be formed by omitting multiple occurrences from s̅_{Q}. A number of occurrences of signal state values of vector s̅_{I,occ} in s̅_{I} may be stored in a vector

$${\overline{n}}_{l , occ} = [ \begin{matrix}{n}_{i , occ} ( 1 ) \\ {n}_{i , occ} ( 2 ) \\ {n}_{i , occ} ( 3 ) \\ ⋮ \\ {n}_{i , occ} ( k ) \\ ⋮ \\ {n}_{i , occ} ( {K}_{i , occ} )\end{matrix} ] , \qquad ( 10 )$$

where an element n_{i,occ}(k) of vector n̅_{I,occ}, indicates the number of occurrences of a signal state at index k in the signal state vector s̅_{I}. For s̅_{Q,occ} the number of occurrences may be stored in a similar way to n̅_{Q,occ}. Correspondingly, the computational signal states may be calculated by

p_{occ}(kₚ)=s_{i,occ}(kᵢ)+js_{q,occ}(k_{q}) (11),

where kᵢ=[1 . . . K_{i,occ}], k_{q}=└1 . . . K_{q,occ}┘, kₚ=K_{q,occ}(kᵢ−1)+k_{q} and K_{p,occ}=K_{i,occ}K_{q,occ} and the number of occurrences corresponding to p_{occ}(kₚ) may be defined by

$${\overline{n}}_{occ} = [ \begin{matrix}{n}_{occ} ( 1 ) \\ {n}_{occ} ( 2 ) \\ {n}_{occ} ( 3 ) \\ ⋮ \\ {n}_{occ} ( {k}_{p} ) \\ ⋮ \\ {n}_{i , occ} ( {K}_{p , occ} - 1 ) \\ {n}_{occ} ( {K}_{p , occ} )\end{matrix} ] , \qquad ( 12 )$$

where n_{occ}(kₚ)=n_{i,occ}(kᵢ)·n_{q,occ}(kᵢ). Thus N_{sub}=K_{p,occ} for signal states comprising all branches.

When at least one of the multiple occurrences of signal states is omitted, the number of second and higher order operations in calculation of the non-linearity metric may be reduced. Improvements may be provided already if only a part of the multiple occurrences are omitted.

In one example Q branch signal states may be defined by

$${\overline{s}}_{Q} = [ \begin{matrix}- 15 \\ 30 \\ 15 \\ 0\end{matrix} ] , \qquad ( 13 )$$

where a multiple occurrence of value ‘15’ is identified as |s_{q}(1)|=|s_{q}(3)|=15. By omitting either s_{q}(1) or s_{q}(3), the reduced signal state vector s̅_{Q,red} comprises only unique values and becomes

$${\overline{s}}_{Q , occ} = [ \begin{matrix}{S}_{q , occ} ( 1 ) \\ {S}_{q , occ} ( 2 ) \\ {s}_{q , occ} ( 3 )\end{matrix} ] = [ \begin{matrix}15 \\ 30 \\ 0\end{matrix} ] . \qquad ( 14 )$$

The number of occurrences of the signal states values of s̅_{Q,occ} in s̅_{Q} may be stored by

$${\overline{n}}_{Q , occ} = [ \begin{matrix}{n}_{q , occ} ( 1 ) \\ {n}_{q , occ} ( 2 ) \\ {n}_{q , occ} ( 3 )\end{matrix} ] = [ \begin{matrix}2 \\ 1 \\ 1\end{matrix} ] , \qquad ( 15 )$$

where it is indicated that the signal state at index 1 in s̅_{Q,occ}, thus ‘15’, occurs twice in s̅_{Q}. Assuming that the signal states of I branch are

$${\overline{s}}_{l} = [ \begin{matrix}10 \\ 20\end{matrix} ] , \qquad ( 16 )$$

the signal state vector s̅_{I,occ} becomes

$${\overline{s}}_{l , occ} = [ \begin{matrix}{s}_{i , occ} ( 1 ) \\ {s}_{i , occ} ( 2 )\end{matrix} ] = [ \begin{matrix}10 \\ 20\end{matrix} ] \qquad ( 17 )$$

and the number of occurrences may be stored by

$${\overline{n}}_{l , occ} = [ \begin{matrix}{n}_{i , occ} ( 1 ) \\ {n}_{i , occ} ( 2 )\end{matrix} ] = [ \begin{matrix}1 \\ 1\end{matrix} ] . \qquad ( 18 )$$

The computational signal states utilizing the number of occurrences can be calculated according to Eq 11 by

$$[ \begin{matrix}{p}_{occ} ( 1 ) \\ {p}_{occ} ( 2 ) \\ {p}_{occ} ( 3 ) \\ {p}_{occ} ( 4 ) \\ {p}_{occ} ( 5 ) \\ {p}_{occ} ( 6 )\end{matrix} ] = [ \begin{matrix}10 + j 15 \\ 10 + j 30 \\ 10 \\ 20 + j 15 \\ 20 + j 30 \\ 20\end{matrix} ] , \qquad ( 19 )$$

and according to the Eq 12 the number of occurrences becomes

$$[ \begin{matrix}{n}_{occ} ( 1 ) \\ {n}_{occ} ( 2 ) \\ {n}_{occ} ( 3 ) \\ {n}_{occ} ( 4 ) \\ {n}_{occ} ( 5 ) \\ {n}_{occ} ( 6 )\end{matrix} ] = [ \begin{matrix}2 \\ 1 \\ 1 \\ 2 \\ 1 \\ 1\end{matrix} ] . \qquad ( 20 )$$

For comparison, without omitting the multiple occurrences the signal states p(1),p(2),p(3), . . . ,p(kₚ), . . . ,p(Kₚ), calculated according to Eq 5 would have become

$$[ \begin{matrix}p ( 1 ) \\ p ( 2 ) \\ p ( 3 ) \\ p ( 4 ) \\ p ( 5 ) \\ p ( 6 ) \\ p ( 7 ) \\ p ( 8 )\end{matrix} ] = [ \begin{matrix}10 - j 15 \\ 10 + j 30 \\ 10 + j 15 \\ 10 \\ 20 - j 15 \\ 20 + j 30 \\ 20 + j 15 \\ 20\end{matrix} ] . \qquad ( 21 )$$

The above exemplary embodiments can be used together in any combination or used separately to reduce the number of signal states and thereby the number of samples in calculating the non-linearity metric.

A power of signal states is calculated in 508. The signal states can be the computational or actual signal states. The power may be calculated from the signal states as the second power of the magnitude of each signal state. The calculation may be performed in the power calculator 406 or 428 for example.

The powers of computational signal states may be obtained by calculating the power of each signal state by:

v(k)=d(k)d(k)* (22),

where ( )* denotes complex conjugate. The signal state d(k) may be the computational signal state p(kₚ) when the number of computational signal states is Kₚ. When the reduced number of signal states K_{p,red} is used the signal state d(k) may be the computational signal state p(k_{p,red}). When the number of occurrences is identified the signal state d(k) may be p(k_{p,occ}).

The powers of actual signal states may be calculated as described in step 610 in FIG. 6.

A non-linearized power of each signal state may be calculated in 510. The calculation may comprise non-linearizing the power of each signal state calculated in 508.

When the signal states comprise computational signal states, the non-linearizing may comprise calculating the i^{th} power of each signal state v(k) i.e. by v(k)ⁱ.

In an exemplary embodiment where the non-linearity metric is a CM, the non-linearizing may comprise calculating a cube of each signal state power, i.e. by cubing each signal state v(k) according to v(k)³. This may be performed in non-linearizers 408 or 430 for example.

When the signal states comprise actual signal states, the non-linearizing may be performed as described in step 612 in FIG. 6.

In 512 a normalization factor for scaling the non-linearized powers of the signal states is calculated.

When the signal states comprise actual signal states, the normalization factor may be

$${v}_{scale} = \frac{1}{K} , \qquad ( 23 a )$$

where K can be the number of actual signal states in 506.

When the signal states comprise computational signal states, the normalization factor may comprise a non-linearized square sum of the gain factors and the number of computational signal states. The calculation of the normalization factor may comprise calculating a square sum of the gain factors and non-linearizing the square sum. The non-linearizing may comprise calculating the i^{th} power of the square sum. The normalization factor may be defined as an inverse of the non-linearized square sum of the gain factors multiplied with the inverse of the number of computational signal states Kₚ for calculating the non-linearity metric. When the non-linearity metric is CM the normalization factor may be defined by:

$${v}_{scale} = \frac{1}{{( {σ}_{betas} )}^{3} {K}_{p}} , \qquad ( 23 b )$$

where Kₚ is the number of signal states and σ_{betas} is the square sum defined by

$${σ}_{betas} = {\sum }_{n = 1}^{N} {\vert {β}_{CH} ( n ) \vert}^{2} . \qquad ( 24 )$$

The calculation of the normalization factor may be performed for example in 404, 412 and 410 in FIG. 4A, and in 424, 434 and 434 in FIG. 4B.

In an exemplary embodiment the calculation of the normalization factor in 512 may comprise selecting a reduced number of gain factors from the received gain factors β_{CH}(1),β_{CH}(2), . . . ,β_{CH}(n), . . . ,β_{CH}(N). The selecting may comprise omitting multiple occurrences (i.e. redundant information) of each gain factor value from the received gain factors. When multiple occurrences of each gain factor value are omitted, β_{CH,occ}(1),β_{CH,occ}(2), . . . ,β_{CH,occ}(n), . . . ,β_{CH}(N_{β,occ}) that contains only unique gain factors may be obtained. The omitting of multiple occurrence may comprise identifying multiple occurrences of gain factor values and selecting the reduced number of gain factor values such that the number of multiple occurrences is reduced, substantially zero or zero in the selected reduced number of gain factors. The number of occurrences of each gain factor may be stored for example to a vector

$${\overline{n}}_{β , occ} = [ \begin{matrix}{n}_{β , occ} ( 1 ) \\ {n}_{β , occ} ( 2 ) \\ {n}_{β , occ} ( 3 ) \\ ⋮ \\ {n}_{β , occ} ( n ) \\ ⋮ \\ {n}_{β , occ} ( {N}_{β , occ} - 1 ) \\ {n}_{β , occ} ( {N}_{β , occ} )\end{matrix} ] , \qquad ( 25 )$$

where an element at index k, together with the same index in β_{CH,occ}(1),β_{CH,occ}(2), . . . ,β_{CH,occ}(n), . . . ,β_{CH,occ}(N_{β,occ}), indicates the number of occurrences of a gain factor in β_{CH}(1),β_{CH}(2), . . . ,β_{CH}(n), . . . ,β_{CH}(N) and N_{β,occ}≦N.

In this way improvements may be provided that comprise for example that redundant calculations in Eqs. (7) and (8) may be omitted and thus the computational load caused by the normalization factor calculation may be reduced. Improvements may be provided already if only a part of the multiple occurrences are omitted.

When at least one of the multiple occurrences of each gain factor values are omitted the square sum of the gain factors may be calculated by multiplying each squared unique gain factor with the stored number of occurrences i.e. by

$${σ}_{betas} = {\sum }_{n = 1}^{{N}_{β , occ}} {n}_{β , occ} ( k ) {\vert {β}_{CH , occ} ( n ) \vert}^{2} . \qquad ( 26 )$$

In this way for example in the calculation of the normalization factor, gain factors may be omitted to reduce the computational load caused by the second order operations without introducing an error to the calculated normalization factor.

In 514 the non-linearized powers of signal states calculated in 510 are scaled. The scaling may comprise integration over the non-linearized powers. The integration may comprise calculating a sum over the non-linearized powers.

When the signal states comprise computational signal states, scaling may be performed with the non-linearized square sum of the gain factors. The scaling may comprise multiplying the non-linearized powers with the normalization factor calculated in 512. When the non-linearity metric is a CM, the scaling and/or the CM may be expressed as:

$${v}_{norm}^{3} = {v}_{scale} {\sum }_{k = 1}^{{K}_{p}} {v ( k )}^{3} . \qquad ( 27 )$$

When the signal states comprise actual signal states, the non-linearized powers of actual signal states may be scaled with the determined number of actual signal states in 506. The scaling may comprise multiplying the non-linearized powers of actual signal states with the normalization factor defined in 512. Thereby, if the reduced number of actual signal states for calculating the non-linearity metric were selected in 506, the scaling may be performed as conventional and according to Eq. (1).

When the reduced number of signal states K_{p,red} is used rather than the number of signal states Kₚ and the non-linearity metric is CM it may be expressed by

$${v}_{norm}^{3} = {v}_{scale} {\sum }_{k = 1}^{{K}_{p , red}} {v ( k )}^{3} . \qquad ( 28 )$$

As the number of signal states K_{p,red} may be smaller than Kₚ the required number of second and higher order operations may be considerably smaller than in the case where all computational signal states Kₚ are used.

When the multiple occurrences of signal state values were omitted in 506 and the non-linearity metric is CM it may be expressed by

$${v}_{norm}^{3} = {v}_{scale} {\sum }_{k = 1}^{{K}_{p , occ}} {n}_{occ} ( k ) \cdot {v ( k )}^{3} . \qquad ( 29 )$$

As the number of signal states K_{p,occ} may be smaller than Kₚ the required number of second and higher order operations may be considerably smaller than in the case where all computational signal states Kₚ are used. Furthermore, because the multiplication with the number of occurrences may be used, the accuracy may not degrade.

In an exemplary embodiment in 514, where the non-linearity metric is a cubic metric, the scaled non-linearity metric value may be converted to a dB value as in 3GPP TS 25.101 that is referenced earlier, where the CM value in decibels is obtained as follows:

CM=CEIL{└20*log 10((vₙₒᵣₘ³)ᵣₘₛ)−20*log 10((vₙₒᵣₘ_{_{—}}_{ref}³)ᵣₘₛ)┘/k,0.5} (30)

in which
(vₙₒᵣₘ³)ᵣₘₛ=\sqrt{vₙₒᵣₘ³} and other parameters of Eq 30 are defined in 3GPP TS 25.101.

It should be noted that the above Eqs 27, 28, 29 and 30 describe calculating the CM. However, they may be easily modified for other orders of non-linearities by replacing the third powers in the equations with the desired order of non-linearity.

In 516, the non-linearity metric value has been calculated. The process ends.

FIG. 6 illustrates a process 600 for calculating a non-linearity metric according to an exemplary embodiment. The process may be performed in a non-linearity metric calculator such as the non-linearity metric calculator in FIG. 4C. In the process the non-linearity metric may be calculated from signal states of a communications signal. The signal states may be either actual signal states or computational signal states of the communications signal to be transmitted. In the calculation, samples with finite values and corresponding to the signal states may be used. FIG. 2A illustrates an example of functional blocks of an apparatus implementing the non-linearity metric calculator. The process begins in 602.

In 604, K samples x(k) are received in the sample selector. The samples may be either computational or actual signal states and the number of samples K may be Kₚ and the sample x(k) may be the computational or actual signal state.

In an exemplary embodiment the received samples correspond to computational signal states in the communications signal as described in the process step 506 in FIG. 5.

In an exemplary embodiment, the received samples x(k) in 604 may be samples of a communications signal comprising physical channels, for example a WCDMA communications signal.

In 606 a reduced number of samples (i.e. subset) N_{sub} to be used in calculating the metric from the received samples K may be determined. The reduced number of samples N_{sub} may be the reduced number of signal states K_{p,red} when the reduced number of signal states is determined. When the number of occurrences is identified the reduced number of samples N_{sub} may be N_{β,occ}.

In an exemplary embodiment the reduced number of samples is determined in 606 on the basis of a number of available processing resources for calculation of the metric. The processing resources may be the number of clock cycles in a DSP or other processing device that is configured to perform the calculation of the non-linear metric.

In an exemplary embodiment, the number of samples to be used in calculation of the metric is determined in 606 such that the calculation requires at most the number of clock cycles available in the cycle budget of the processing device.

In an exemplary embodiment, the number of samples N_{sub} may be determined in 606 such that the accuracy requirement of the non-linearity metric is met. The accuracy requirement may be defined as an error in the non-linearity metric caused by using N_{sub} samples in the calculation instead of all the samples K. The accuracy requirement may be set by the system performance and the tests defined in the specifications. The number of samples N_{sub} can be determined by known engineering means such as simulations, measurements and configuration of the system.

In 608, the reduced number of N_{sub} samples

$${\overline{x}}_{sub} = [ \begin{matrix}{x}_{sub} ( 1 ) \\ {x}_{sub} ( 2 ) \\ {x}_{sub} ( 3 ) \\ ⋮ \\ {x}_{sub} ( n ) \\ ⋮ \\ {x}_{sub} ( {N}_{sub} )\end{matrix} ] \qquad ( 31 )$$

may be selected on the basis of a threshold value from the received K samples in x(k). When the reduced number of signal states is determined (i.e. N_{sub}=K_{p,red}) the sample x_{sub}(n) may be the computational signal state p(k_{p,red}). When the number of occurrences is identified (i.e. N_{sub}=K_{p,occ}) the sample x_{sub}(n) may be p(k_{p,occ}).

Due to the powers of x(k) in non-linearity metric calculation (see Eq. 2) sample values of high magnitude may dominate in the resulting non-linearity metric value (see Eq. 1). Therefore, the non-linearity metric value obtained by using the reduced number N_{sub} of samples may provide a good estimate of the non-linearity metric value if the reduced number of samples is selected so that it comprises the sample values whose magnitude is high. Furthermore, the computational complexity of the calculation of the non-linearity metric value using the reduced number of samples N_{sub} may be less than the computational complexity if all the samples K were used.

In an exemplary embodiment in 608 the threshold value comprises a threshold for a number of samples and the reduced number of samples may be selected on the basis of the threshold for the number of samples N_{sub}. The threshold number of samples may be a predefined number of samples. The threshold for the number of samples may be determined for example as in 606. In the embodiment N_{sub} samples from the received samples x(k) may be selected to the reduced number of samples x̅_{sub}. The selecting may comprise:
determining a predefined number of samples N_{sub} to be selected (i.e. the threshold);
determining the magnitudes of the received samples x(k);
identifying N_{sub} highest magnitudes of the received samples; and
storing the received samples corresponding to the identified magnitudes to x̅_{sub}.

In an exemplary embodiment in 608 the threshold value may be a threshold for sample magnitude and the samples may be selected on the basis of the threshold for the sample magnitude xₜₕ. In this embodiment the sample magnitudes of x(k) may be compared against the threshold magnitude and the sample magnitudes exceeding the threshold magnitude may be selected to the reduced number of samples. The threshold may be, for example, a preset threshold or a moving threshold that may be defined relative to the highest magnitude of a sample in the received samples x(k).

In an exemplary embodiment, the highest sample magnitude in the received samples may be determined by:

xₘₐₓ=max(|x(k)|) (32),

where k=[1,2, . . . K], and the threshold value may be set so that xₘₐₓ>xₜₕ and xₜₕ=b*xₘₐₓ, where b is a predefined value defining the ratio of xₜₕ and xₘₐₓ.

For example, the threshold magnitude xₜₕ may be set to 10% of the magnitude of the highest sample xₘₐₓ by setting xₜₕ=0.10*xₘₐₓ. In this example, all samples whose magnitude is greater than 10% of the magnitude of the highest sample are selected to the reduced number of samples x̅_{sub}. Thus, according to this embodiment N_{sub} may be the number of samples in x̅_{sub}.

In an exemplary embodiment the threshold for sample magnitude xₜₕ may be a preset threshold for the sample magnitude. In the embodiment the reduced number of samples x̅_{sub} may be selected by comparing the magnitude of each sample x(k) with the preset threshold magnitude. Accordingly, the reduced number of samples x̅_{sub} may be formed from samples fulfilling:

|x(k)|>xₜₕ (33).

Thus, N_{sub} may be the number of samples in x̅_{sub}.

When a reduced number of samples are selected the number of computational operations to calculate the non-linearity metric may be decreased and/or more time may be left for the PA to settle. Exemplary improvements may further comprise that power may be saved due to the reduced number of computational operations consumed in the calculation of the non-linearity metric.

In 610 a power of each sample in x_{sub}(n) may be calculated as the second power of the sample magnitude, thus |x(n)|². The calculation may be performed in power calculator 444 for example.

In 612 a non-linearized power of each of the samples x_{sub}(n) is calculated. The calculation may comprise non-linearizing the power of each sample calculated in 610. The non-linearizing may comprise calculating the i^{th} power of each sample power |x(n)|², thus (|x(n)|²)ⁱ.

In an exemplary embodiment, where the non-linearity metric is CM, in 612 the powers of the samples may be cubed, thus (|x(n)|²)³ may be calculated. This may be performed in non-linearizer 446 for example.

In 614 a non-linearity metric value may be formed by scaling the non-linearized sample powers. The scaling may comprise integration over the non-linearized sample powers. The integration may comprise calculating a sum over the non-linearized sample powers.

In an exemplary embodiment, where the non-linearity metric is a cubic metric the non-linearized values may be scaled by multiplying them with normalization factor that may be calculated according to Eq 23a when the samples are actual signal states and according to Eq 23b when the samples are computational signal states. The scaling may be performed in the scaler 448.

In an exemplary embodiment, where the non-linearity metric is a CM, the scaled CM value may be converted to a dB value as in step 514 and 3GPP TS 25.101 referenced earlier.

In 616, the metric value has been calculated and the process ends.

FIG. 7 illustrates a process for calculating a non-linearity metric for controlling a power amplifier. In the process the non-linearity metric may be calculated from signal states of a communications signal to be transmitted. The signal states may be either actual signal states or computational signal states of the communications signal to be transmitted. In the calculation, samples with finite values and corresponding to the signal states may be used. The process may be performed in a non-linearity metric calculator such as the non-linearity metric calculator in FIG. 4D. FIG. 3A or 3B illustrate examples of functional blocks of an apparatus implementing the non-linearity metric calculator. The process begins in 700.

In 702, K samples x(k) corresponding to signal states may be received. The samples may correspond to either computational or actual signal states of a communications signal to be transmitted. The samples may be either chip or symbol rate samples.

In an exemplary embodiment the samples may be samples of physical channels CH₁, CH₂, . . . , CH_{K} corresponding to sub-carriers to be transmitted in a communications signal.

In an exemplary embodiment the samples may be samples of a multi-carrier communications signal, for example OFDM symbol samples.

In 704, number of samples N_{sub} to be used in calculating the non-linearity metric from the received samples K may be determined. N_{sub} may be determined for example as in step 606 in FIG. 6, for example on the basis of available clock cycles of the processing device.

In 706, the process may be continued to 708 if the received samples are not samples of an OFDM symbol and to 710 if the received samples are samples of OFDM symbols.

In 708, a reduced number of N_{sub} samples from the received samples may be selected by performing an N_{sub}-point IDFT on the received samples x(k). The IDFT generates the N_{sub} OFDM symbol samples, thus the reduced number of samples x̅_{sub}.

In 710, a reduced number of N_{sub} samples may be selected from the OFDM symbol samples in the received samples x(k).

In an exemplary embodiment, in 710, a reduced number of N_{sub} consecutive samples from the received samples x(k) are selected. The consecutive samples may be selected as N_{sub} consecutive samples from the beginning, from the end or from the middle of the sequence of the received samples x(k).

In an exemplary embodiment samples at regular intervals are selected from x(k) of K samples. Samples at regular intervals may be selected by selecting every L^{th} sample from x(k) of K samples, for example so that:

x_{sub}(n)=x[n×L] (33),

where n=0, 1, 2, . . . N_{sub}−1 and L=K/N_{sub}.

In 712, a power of each sample in may be calculated as the second power of the sample magnitude. The calculation may be performed in the power calculator 464 for example.

In 714, a non-linearized power of each sample may be calculated. The calculation may comprise non-linearizing the power of each sample x_{sub}(n) calculated in 712. The non-linearizing may comprise calculating the i^{th} power of each sample power |x(n)|², thus (|x(n)|²)ⁱ.

In an exemplary embodiment, where the non-linearity metric is a cubic metric, in 714 the powers of the samples may be cubed, thus (|x(n)|²)³ is calculated. This may be performed in the non-linearizer 466 for example.

In 716, a non-linearity metric value may be formed by the scaling non-linearized sample powers. The scaling may comprise integration over the non-linearized sample powers. The integration may comprise calculating a sum over the non-linearized sample powers.

In an embodiment, where the non-linearity metric is a CM, cubic sample values may be scaled by multiplying them with 1/N_{sub}, where N_{sub} is the number of OFDM symbol samples in x̅_{sub}. The scaling may be performed in the scaler 468.

In an exemplary embodiment, the scaled CM value may be converted to a dB value as in step 514 and 3GPP TS 25.101 referenced earlier.

In 718, the non-linearity metric value has been calculated and the process ends.

The non-linearity metric calculators 400, 420, 440 and 460 may be implemented as any kind of processor programmable to execute numeric calculations such as an embedded processor, a Digital Signal Processor (DSP), a Master Control Unit (MCU) or an Application Specific Integrated Processor (ASIP). The non-linearity metric calculators may also be implemented as an electronic digital computer, which may comprise a working memory (RAM), a central processing unit (CPU) or a processor, and a system clock. The CPU may comprise a set of registers, an arithmetic logic unit, and a control unit. The control unit is controlled by a sequence of program instructions transferred to the CPU from the RAM. The control unit may contain a number of microinstructions for basic operations. The implementation of microinstructions may vary, depending on the CPU design. The program instructions may be coded by a programming language, which may be a high-level programming language, such as C, Java, etc., or a low-level programming language, such as a machine language, or an assembler. The electronic digital computer may also have an operating system, which may provide system services to a computer program written with the program instructions.

An embodiment may include a computer program embodied on a computer storage medium, comprising program instructions which, when loaded into an electronic apparatus, constitute the non-linearity metric calculators 400, 420, 440 or 460 described earlier.

The computer program may be in source code form, object code form, or in some intermediate form, and it may be stored in some sort of carrier, which may be any entity or device capable of carrying the program. Such carriers include a record medium, computer memory, read-only memory, for example. Depending on the processing power needed, the computer program may be executed in a single electronic digital computer or processor or it may be distributed amongst a number of computers or processors.

The steps/points and related functions described above in FIGS. 5, 6 and 7 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point. The calculation of non-linearity metric value, illustrate a procedure that may be implemented in one or more physical or logical entities.

The techniques described herein may be implemented by various structures, devices, and means so that an apparatus implementing one or more functions of a non-linearity metric calculator described with an embodiment comprises not only prior art means, but also means for implementing the one or more functions of a corresponding apparatus described with an embodiment and it may comprise separate means for each separate function, or means may be configured to perform two or more functions. For example, these techniques may be implemented using a combination of hardware (one or more apparatuses), firmware (one or more apparatuses), and software (one or more modules). The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Exemplary embodiments further include a method comprising receiving samples corresponding to signal states of a power amplifier.

Exemplary embodiments further include an apparatus configured to: receive samples corresponding to signal states of a communications signal to be transmitted, calculate, on the basis of a reduced number of samples selected from the received samples, a non-linearity metric for controlling a power amplifier.

Exemplary embodiments further include a computer program stored on a computer storage medium and comprising instructions which are operable to control a data processing means or processor to perform a method comprising receiving samples corresponding to signal states of a communications signal to be transmitted, calculating, on the basis of a reduced number of samples selected from the received samples, a non-linearity metric for controlling a power amplifier.

Exemplary embodiments further include an apparatus comprising means for receiving samples corresponding to signal states of a communications signal to be transmitted, calculating, on the basis of a reduced number of samples selected from the received samples, a non-linearity metric for controlling a power amplifier.

Exemplary embodiments further include a system comprising at least one apparatus according to one or more exemplary embodiments.

According to an aspect, in the exemplary embodiments the received samples may correspond to computational signal states of the communications signal.

According to an aspect, the exemplary embodiments may comprise determining the computational signal states on the basis of gain factors corresponding to channels that are combined to be transmitted in the communications signal.

According to an aspect, in the exemplary embodiments the received samples may correspond to actual signal states of the communications signal.

According to an aspect, in the exemplary embodiments the received samples may correspond to sub-carriers to be transmitted in the communications signal.

According to an aspect, wherein the received samples correspond to sub-carriers to be transmitted in the communications signal, the exemplary embodiments may comprise selecting the reduced number of samples from the received samples by performing an N_{sub}-point IDFT on the received samples, the N_{sub}-point IDFT generating the reduced number of samples.

According to an aspect, in the exemplary embodiments the received samples may comprise samples of a multi-carrier communications signal.

According to an aspect, where the received samples comprise samples of a multi-carrier communications signal, the exemplary embodiments may comprise selecting the reduced number of samples from the beginning, from the end or from the middle of the sequence of the received samples.

According to an aspect, where the received samples comprise samples of a multi-carrier communications signal, the reduced number of samples may be selected from the received samples at regular intervals.

According to an aspect, in the exemplary embodiments, the samples of a multi-carrier communications signal may comprise OFDM symbols.

According to an aspect, the exemplary embodiments may comprise selecting the reduced number of samples from the received samples on the basis of a threshold value.

According to an aspect, in the exemplary embodiments the threshold value may comprises a threshold value for sample magnitude.

According to an aspect, in the exemplary embodiments the threshold value may comprises a threshold value for the number of samples.

According to an aspect, wherein the threshold value comprises a threshold value for sample magnitude, in the exemplary embodiments the threshold value may be relative to the magnitude of the sample with the highest magnitude in the received samples.

According to an aspect, wherein the threshold value comprises a threshold value for the number of samples, the exemplary embodiments may comprise selecting the threshold value N_{sub} number of received samples with the highest magnitudes.

According to an aspect, wherein the threshold value comprises a threshold value for the number of samples, in the exemplary embodiments the threshold for the number of computational signal states N_{sub} may be determined on the basis of a number of available clock cycles for calculating the non-linearity metric.

According to an aspect, the exemplary embodiments may comprise selecting the reduced number of samples to meet an accuracy requirement of the non-linearity metric.

According to an aspect, in the exemplary embodiments, the non-linearity metric may be a cubic metric.

According to an aspect, in the exemplary embodiments, the communications signal may be a WCDMA signal or an OFDM signal.

It will be obvious to a person skilled in the art that, as the technology advances, the inventive concept can be implemented in various ways. The invention and its embodiments are not limited to the examples described above but may vary within the scope of the claims.

We claim:

1. A method, comprising:
receiving gain factors for channels that are combined to be transmitted in a communications signal; and
calculating, on the basis of the gain factors, a non-linearity metric.

2. The method according to claim 1 comprising:
determining signal states of the communications signal;
selecting a reduced number of signal states from the determined signal states; and
calculating the non-linearity metric on the basis of the selected reduced number of signal states.

3. The method according to claim 2, wherein the signal states are determined on the basis of the gain factors.

4. The method according to claim 2, wherein the selecting comprises:
selecting a predefined number of signal states with the highest magnitudes from the determined signal states.

5. The method according to claim 2, wherein the selecting comprises:
omitting at least one additive inverse value of the signal states.

6. The method according to claim 2, wherein the selecting comprises:
omitting at least one multiple occurrence of each signal state value.

7. The method according to claim 2, wherein the selecting comprises:
selecting signal states that exceed a threshold value for a signal state magnitude.

8. The method according claim 1, wherein the calculating the non-linearity metric comprises:
calculating a normalization factor, on the basis of the gain factors.

9. The method according to claim 8, comprising:
omitting multiple occurrences of each gain factor value from the received gain factors.

10. The method according claim 2, wherein the signal states are computational signal states or actual signal states of the communications signal.

11. The method according to claim 1, wherein the non-linearity metric is a cubic metric.

12. The method according to claim 1, wherein the communications signal is at least one from the group comprising a wideband code division multiple access signal, or an orthogonal frequency-division multiplexing signal.

13. An apparatus, comprising:
a receiver configured to receive gain factors for channels that are combined to be transmitted in a communications signal; and
a processor configured to calculate, on the basis of the gain factors, a non-linearity metric to control a transmission power of the communications signal.

14. The apparatus according to claim 13, wherein the processor is further configured to determine signal states of the communications signal, select a reduced number of signal states from the determined signal states, and calculate the non-linearity metric on the basis of the selected reduced number of signal states.

15. The apparatus according to claim 14, wherein the processor is further configured to determine the signal states on the basis of the gain factors.

16. The apparatus according to claim 14, wherein the processor is further configured to select a predefined number of signal states with the highest magnitudes from the determined signal states.

17. The apparatus according to claim 16, wherein the processor is further configured to determine the threshold number of signal states N_{sub} on the basis of a number of available clock cycles for calculating the non-linearity metric.

18. The apparatus according to claim 14, wherein the processor is further configured to omit at least one additive inverse value of the signal states.

19. The apparatus according to claim 14, wherein the processor is further configured to omit at least one multiple occurrence of each signal state value.

20. The apparatus according to claim 14 wherein the processor is further configured to select signal states that exceed a threshold value for a signal state magnitude.

21. The apparatus according to claim 13 wherein the processor is further configured to calculate a normalization factor, on the basis of the gain factors.

22. The apparatus according to claim 21, wherein the processor is further configured to omit multiple occurrences of each gain factor value from the received gain factors.

23. The apparatus according to claim 13, wherein the signal states are computational signal states or actual signal states of the communications signal.

24. The apparatus according to claim 13, wherein the non-linearity metric is a cubic metric.

25. The apparatus according to claim 13, wherein the communications signal is at least one from the group comprising a wideband code division multiple access signal, or an orthogonal frequency-division multiplexing signal.

26. The apparatus according to claim 13, wherein the receiver and the processor comprises an integrated processor or a chip.

27. The apparatus according to claim 13, wherein the apparatus comprises at least one from the group comprising: user equipment, a mobile phone, a base station, a Node-B, a relay station or an access point.

28. An apparatus comprising:
receiving means for receiving gain factors for channels that are combined to be transmitted in a communications signal; and
calculating means for calculating, on the basis of the gain factors, a non-linearity metric for controlling a transmission power of the communications signal.

29. The apparatus according to claim 28, further comprising
determining means for determining signal states of the communications signal;
selecting means for selecting a reduced number of signal states from the determined signal states; and
calculating means for calculating the non-linearity metric on the basis of the selected reduced number of signal states.

30. A computer program stored on a computer-storage medium, the computer program configured to control a processor to perform operations comprising:
receiving gain factors for channels that are combined to be transmitted in a communications signal; and
calculating, on the basis of the gain factors, a non-linearity metric.

31. The computer program according to claim 30, the operations further comprising:
determining signal states of the communications signal;
selecting a reduced number of signal states from the determined signal states; and
calculating the non-linearity metric on the basis of the selected reduced number of signal states.
